(19) United States
(12) Patent Application Publication
(10) Pub. No.: US 2024/0362329 A1
(43) Pub. Date: Oct. 31, 2024

(54) AUTOMATED ANALYSIS AND UNDERSTANDING OF MALICIOUS EXCEL 4.0 (XL4) MACROS

(71) Applicant: VMware LLC, Palo Alto, CA (US)

(72) Inventors: Giovanni Vigna, Santa Barbara, CA (US); Stefano Ortolani, Twickenham (TW); Nicola Ruaro, Goleta, CA (US); Fabio Pagani, Santa Barbara, CA (US); Christopher Kruegel, Santa Barbara, CA (US)

(21) Appl. No.: 18/308,254

(22) Filed: Apr. 27, 2023

(51) Int. Cl. G06F 21/56

(52) U.S. Cl. CPC G06F 21/566; G06F 2221/033

(57) ABSTRACT

Techniques that leverage symbolic execution to automatically analyze and understand malicious XL4 macros is provided. Using symbolic execution, these techniques can automatically infer the “correct” values for environmental inputs that are employed by advanced XL4 malware for obfuscating their malicious payloads, thereby allowing for a complete analysis of such malware.

### BACKGROUND

Unless specifically indicated herein, the approaches described in this section should not be construed as prior art to the claims of the present application and are not admitted as being prior art by inclusion in this section.

Malicious software (i.e., malware) poses a significant threat to the security of computer networks and users. In the ever-evolving malware landscape, Microsoft Excel 4.0 (XL4) macros have recently become an important attack vector. Malicious XL4 macros are often hidden within apparently legitimate Excel files and under several layers of obfuscation. As such, they are difficult to analyze using static analysis techniques. Moreover, analyzing these macros in a dynamic analysis environment is challenging because they are often designed to execute “correctly” (i.e., in a manner that reveals their malicious intent) only under specific environmental conditions that are difficult to create.

### BRIEF DESCRIPTION OF THE DRAWINGS

FIG. 1 depicts an example XL4 macro.

FIG. 2 depicts the architecture of SYMBEXCEL according to certain embodiments.

FIG. 3 depicts a workflow that may be performed by the symbolic execution engine of SYMBEXCEL according to certain embodiments.

FIG. 4 depicts another example XL4 macro.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof.

Embodiments of the present disclosure are directed to a novel computer-implemented tool, referred to as SYMBEXCEL, that leverages symbolic execution to automatically analyze and understand malicious XL4 macros (i.e., XL4 malware). Symbolic execution is a program analysis technique that executes a computer program by assigning symbolic variables, rather than concrete values, to the program's inputs. Upon encountering a conditional instruction that depends on a symbolic variable, the execution is forked and constraints on the symbolic variable that are introduced by the forking are tracked. The tracked constraints are subsequently solved to determine the input values that trigger each branch of the program.

Using symbolic execution, SYMBEXCEL can automatically infer the “correct” values for environmental inputs that are employed by advanced XL4 malware for obfuscating their malicious actions (i.e., payloads)—in other words, the environmental input values that lead to deobfuscation of those actions. Thus, SYMBEXCEL can advantageously expose and understand the complete behavior of such malware, without requiring a fallback to time-consuming manual analysis.

### 1. Overview of Excel File Formats, XL4 Macros, and Existing Approaches for Analyzing XL4 Malware

### 1.1 Excel File Formats

Microsoft Excel supports several different file formats, of which four can contain XL4 macros: Excel 97—Excel 2003 Workbook (.xls), Excel Binary Workbook (.xlsb), Excel Workbook (.xlsx), and Excel Macro-Enabled Workbook (.xlsm). The first two are binary file formats, also known as Binary Interchange File Format 8 (BIFF8) and Binary Interchange File Format 12 (BIFF12) respectively. The latter two are text file formats that are based on Extensible Markup Language (XML).

Regardless of the specific file format used, every Excel file consists of a workbook that includes one or more spreadsheets. Each spreadsheet in turn comprises a grid of fields, known as cells, where data can be input and stored. A spreadsheet may be classified as a macro sheet or as a worksheet, with the main difference being that macro sheets can contain XL4 macros and worksheets cannot. Finally, a workbook can contain one or more globally-defined variables, known as defined names, that have associated values and are shared across the workbook.

### 1.2 XL4 Macros

XL4 macros are a 30-year-old feature of Microsoft Excel that allows users to encode a series of operations into an Excel file. This feature originated as a precursor of Visual Basic for Applications (VBA) macros, which is another Excel macro format. Despite the introduction of VBA macros as a replacement for XL4 macros, the latter are still supported by the latest version of Excel.

An XL4 macro is a sequence of formulas that are stored in the cells of a macro sheet, with one formula per cell. Each formula is an expression that begins with an equal sign and references/calls one or more Excel 4.0 macro functions (XL4 functions). XL4 functions are a super-set of the traditional spreadsheet functions supported by Excel and allow XL4 macros to interact with both the workbook in which they are contained and the execution environment in which they are run. For example, unlike traditional Excel spreadsheet functions such as SUM and COUNT, some XL4 functions can interface with the underlying operating system (OS) and invoke OS-level operations (e.g., return a directory listing, execute a program, etc.). Other XL4 functions can access environmental information such as the total amount of system memory available to Excel, the size/position of the Excel window, the name/version of the OS, the current date/time, and so on.

The control flow of an XL4 macro begins by executing the formula in an initial cell and continues executing the formulas in following cells until either a terminating formula is encountered (e.g., =HALT ( )) or a control-flow transferring function is executed (e.g., GOTO (cell)). In the latter case, the control flow continues with the formula in the target cell. Using the XL4 functions FORMULA and FORMULA. FILL, XL4 macros can also generate formulas dynamically and store them in a macro sheet for later execution.

### 1.3 XL4 Malware and Existing Analysis Approaches

In recent years, malware campaigns using XL4 malware have been deployed at scale and infections related to this threat have increased. Accordingly, there is a growing need for post-mortem tools that can analyze the malicious payloads of XL4 malware samples in an automated fashion and extract indicators of compromise (IoCs) from those samples to prevent future infections.

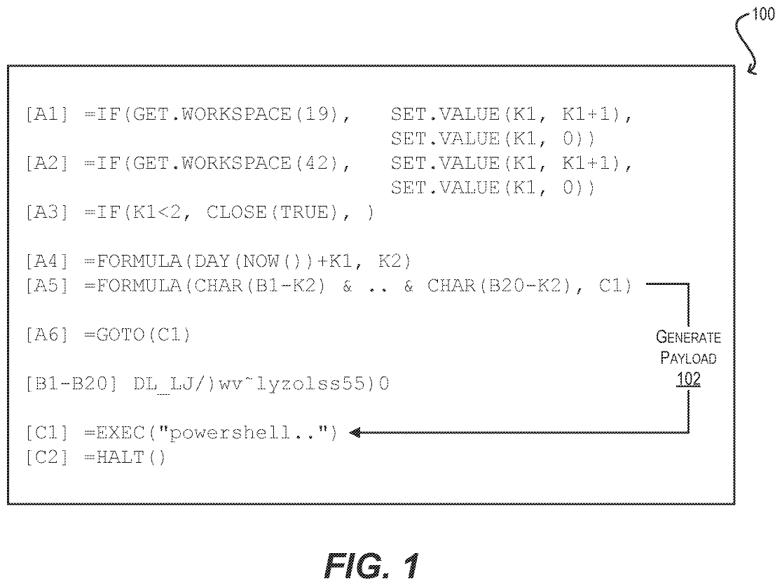

Existing approaches for analyzing XL4 malware include static analysis, which involves collecting information about the malware without running it, and dynamic analysis, which involves analyzing how the malware behaves when run in a controlled environment (i.e., sandbox). Unfortunately, many types of advanced XL4 malware deployed today employ obfuscation techniques that use runtime environmental inputs to hide/encrypt their malicious payloads, thereby hindering both static and dynamic analysis. FIG. 1 depicts an example malicious XL4 macro 100 that implements some of these obfuscation techniques. Macro 100 operates as follows:
1. The first two formulas in cells A1 and A2 call the GET. WORKSPACE function to determine whether the environment in which the macro is run has audio and mouse capabilities. If these capabilities are detected, the value in cell K1 is incremented accordingly.
2. The formula in cell A3 checks whether the value in cell K1 is less than 2 and, if so, aborts execution by calling the CLOSE function. K1 will be less than 2 if either mouse or sound capabilities are not detected per cells A1 and A2, and thus the formula in cell A3 acts as an “anti-analysis” or “sandbox fingerprinting” check that prevents the macro from revealing its malicious payload if it is run in a dynamic analysis environment (i.e., sandbox).
3. The formulas in cells A4 and A5 are responsible for deobfuscating (i.e., decrypting) macro 100's malicious payload. In particular, the formula in cell A4 retrieves the current day of the week using the DAY and NOW functions, adds this to the value in cell K1, and stores the result in cell K2. The formula in cell A5 then subtracts the value in cell K2 from the characters in the cell range B1-B20, concatenates the resulting characters together, and stores the concatenated result in cell C1. Upon completion of this operation, cell C1 will hold the decrypted malware payload, which in this example is a formula that calls the EXEC function to run a command using powershell (shown via reference numeral 102).
4. The formula in cell A6 transfers the macro's control flow to cell C1, thus causing the decrypted payload stored there (=EXEC (“powershell . . . ”)) to be executed. Finally, the macro is halted at cell C2.

With the obfuscation techniques shown in FIG. 1, static analysis cannot fully understand the behavior of macro 100 because its malicious payload is not discernable by simply reading the macro's formulas. This payload only comes into existence in cell C1 upon executing the formulas in the preceding cells, which use environment variables populated via the GET. WORKSPACE and NOW functions to decrypt the contents of cells B1-B20 and to dynamically generate the payload.

Significantly, dynamic analysis is also ineffective in understanding the complete behavior of macro 100 because conventional dynamic analysis tools generally rely on a default execution environment that is common to all malware samples being analyzed. This default execution environment, which is typically a functionally stripped-down virtual machine, may not have mouse and audio capabilities as required by the anti-analysis check implemented via cells A1-A3. Further, even if the default execution environment is configured to provide mouse and audio capabilities, it is difficult for dynamic analysis tools to infer a priori the correct day of the week that macro 100 expects at cell A4. Using a “wrong” value here will result in the generation of an invalid payload in cell C1 and thus will hide the true behavior of macro 100.

A workaround for this problem is to couple dynamic analysis with forced execution, which is a technique that forces the macro to take different branches on conditional instructions and uses brute force to iterate over different environment variables. However, this technique suffers from its own set of limitations. First, while forced execution can bypass simple conditional checks, it does not guarantee the correct environment configuration when forcing execution down a particular branch. For example, in macro 100 of FIG. 1, if the value in cell K1 is equal to 1 when executing the formula in cell A3, forced execution can divert the macro's control flow towards the “false” branch and enable it to reach the deobfuscation routine in cell A5, but the value of cell K1 will be wrong. As a result, the malicious payload will not be correctly decrypted in cell C1.

Second, forced execution requires identifying the subset of environment variables that are relevant for deobfuscation and finding an efficient strategy to test several combinations of their values. It is reasonable to apply this technique to test different days of the week as used in cell A4 of macro 100 because there are only seven possible values. However, for real-world XL4 malware samples that use more complex environment configurations, the search space quickly increases in size and makes forced execution infeasible.

### 2. SYMBEXCEL Architecture

To address the foregoing and other related problems, embodiments of the present disclosure provide SYMBEXCEL, a novel tool that uses symbolic execution to automatically analyze XL4 malware, and in particular advanced XL4 malware that relies on obfuscation techniques to hide their malicious payloads. SYMBEXCEL may be implemented in software that runs on a general purpose computer system/device, in hardware, or via a combination thereof.

As mentioned previously, symbolic execution executes computer programs in the abstract domain of symbolic variables rather than concrete values. SYMBEXCEL leverages this technique for tracking how environmental inputs are retrieved, propagated, and used during the execution of a malicious XL4 macro, which in turn allows the tool to infer, in a structured way, the appropriate values for those inputs that lead to deobfuscation of the macro's payload.

For example, with respect to macro 100 of FIG. 1, when the GET. WORKSPACE function is executed in cell A1, SYMBEXCEL can postpone the decision on the concrete value this function should return and instead can bind a symbolic variable to the function's output. Then, because this symbolic variable is used in an IF function at cell A3, SYMBEXCEL can fork the macro's execution into two branches with two separate execution states: a first state that follows the “true” branch and contains the constraint K1=1, and a second state that follows the “false” branch and contains the constraint K1=0. A similar process can be repeated for the call to GET. WORKSPACE in cell A2, resulting in four possible branches and execution states at cell A3. Only one of these branches will contain K1=2 in its execution state, and thus that will be the branch that reaches the deobfuscation routine in cell A5; the three other branches will be terminated after executing the formula in cell A3.

Moreover, when the NOW function is executed in cell A4, SYMBEXCEL can bind another symbolic variable to that function's output and pass this symbolic variable through the formulas in cells A4 and A5, resulting in a symbolic expression in cell C1 that represents the macro's decrypted payload. Then, upon reaching C1, SYMBEXCEL can concretize the symbolic expression in this cell-or in other words, convert it into a concrete value-thereby allowing the decrypted payload to be revealed and executed. Note that this concretization step is delayed until needed to make forward progress (i.e., at cell C1), which ensures efficient exploration of all possible execution paths of the macro.

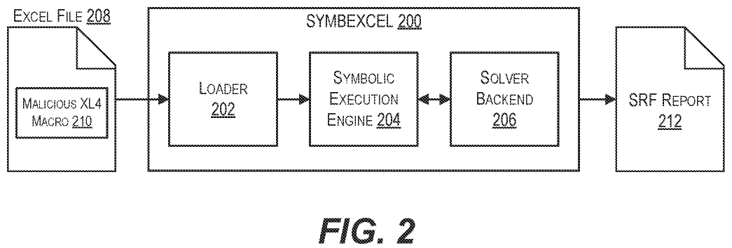

FIG. 2 is a simplified block diagram of an example architecture for SYMBEXCEL (reference numeral 200) according to certain embodiments. As shown, this architecture includes three main components: a loader 202, a symbolic execution engine (hereinafter simply “engine”) 204, and a solver backend 206.

At a high level, loader 202 can receive an Excel file 208 that contains a malicious XL4 macro 210, parse the file in accordance with its underlying file format (e.g., .xls, .xlsb, .xlsx, or .xlsm), and extract information from the file that is needed by SYMBEXCEL for analysis purposes. This information can include, among other things, the entry point for initiating analysis of macro 210 and the content (e.g., formulas and values) of all spreadsheets in file 208's workbook.

Engine 204 can receive the information extracted by loader 202 and orchestrate an execution of macro 210 that uses symbolic variables to model the macro's environmental inputs. As part of this process (referred to as symbolic exploration), engine 204 can fork the execution into separate branches after every conditional instruction (e.g., IF function, etc.) and keep track of the constraints introduced by the forking events in execution states associated with the branches.

Upon reaching a point in a branch where a symbolic variable/expression needs to be concretized in order to make forward progress, engine 204 can pass the branch's execution state to solver backend 206, which can be implemented using an SMT (satisfiability modulo theories) constraint solver. Solver backend 206 can check the satisfiability of the constraints accumulated within the execution state, translate the symbolic variable/expression into a concrete value that is consistent with the constraints, and return the concrete value to engine 204.

Finally, once engine 204 has completed its symbolic exploration and evaluated all possible execution paths of macro 210, SYMBEXCEL can generate and output a report 212 comprising a list of all security-relevant formulas (SRFs) that were observed/found during the symbolic exploration. Report 212 can be subsequently parsed by a downstream tool or system to extract IoCs such as filenames, uniform resource locators (URLs), shell commands, registry keys, and the like. For example, with respect to macro 100 of FIG. 1, the formula =EXEC (“powershell . . . ”) can be parsed to extract the shell command “powershell . . . ” In a particular embodiment, a formula that references any of the following XL4 functions may be considered an SRF: EXEC, CALL, REGISTER, FOPEN, FWRITE, and FWRITELN.

The following sub-sections describe loader 202, engine 204, and solver backend 206 in greater detail, including certain optimizations/enhancements that may be implemented by these components to improve their efficiency and/or effectiveness. It should be appreciated that the architecture shown in FIG. 2 is illustrative and not intended to limit embodiments of the present disclosure. For example, although FIG. 2 depicts a particular arrangement of SYMBEXCEL components, other arrangements are possible (e.g., the functionality attributed to a particular component may be split into multiple components, components may be combined, etc.). One of ordinary skill in the art will recognize other variations, modifications, and alternatives.

### 2.1 Loader

As noted above, loader 202 is responsible for parsing file 208 comprising macro 210 and extracting all of the information needed by SYMBEXCEL to start its analysis of the macro. Such information can include the name and content of each spreadsheet in file 208's workbook, the entry point (explained below), defined names, the formulas and values in each cell, and the properties of each cell (e.g., font information background color, etc.). SYMBEXCEL uses this information to create an instance of engine 204 and to initialize the execution state of that instance to reflect the contents of file 208.

In certain embodiments, loader 202 can employ one of two parsing approaches: a first approach that relies on a static parser and a second approach that relies on a COM (Component Object Model) loader. The static parser uses public knowledge regarding the BIFF8/12 and XML-based Excel file formats to carry out its parsing of file 208. One example of such a static parser is the open-source Python library called xlrd2. In contrast, the COM loader uses the Microsoft COM interface to load file 208 directly into a running instance of Excel, which then parses the file on behalf of SYMBEXCEL.

The static parser approach generally allows for faster loading times than the COM loader approach and thus may be preferable for scenarios where such faster performance is highly desirable (such as, e.g., analysis of a large batch of malware samples). On the other hand, the static parser approach is less robust because implementing an Excel file parser is inherently difficult, and malicious actors are routinely finding new ways to break the static parsers of analysis tools while preserving file validity with respect to Excel. Accordingly, using the COM loader may be the safer option for recently developed XL4 malware.

2.1.1 Entry point

There are a number of different ways in which the execution of macro 210 may be initiated/triggered. Accordingly, it is important for loader 202 to extract the specific entry point- or in other words, the triggering mechanism—for macro 210 within file 208 so that SYMBEXCEL can begin its analysis from that point. One category of entry points pertains to the built-in functionalities of Excel 4.0 macro sheets. In particular, such a macro sheet can include an “Auto_Open,” “Auto_Close,” “Auto_Activate,” or “Auto_Deactivate” label specifying that macro 210 will be automatically run when the sheet is opened, closed, activated, or deactivated respectively. Extracting this type of entry point information is relatively straightforward because it is stored using well-known (constant) label names.

It is also possible for macro 210 to be triggered by VBA code within file 208. In this scenario, loader 202 can search for an invocation of the “Application. Run” method in the VBA code and parse this method invocation to extract the entry point.

### 2.2 Symbolic Execution Engine

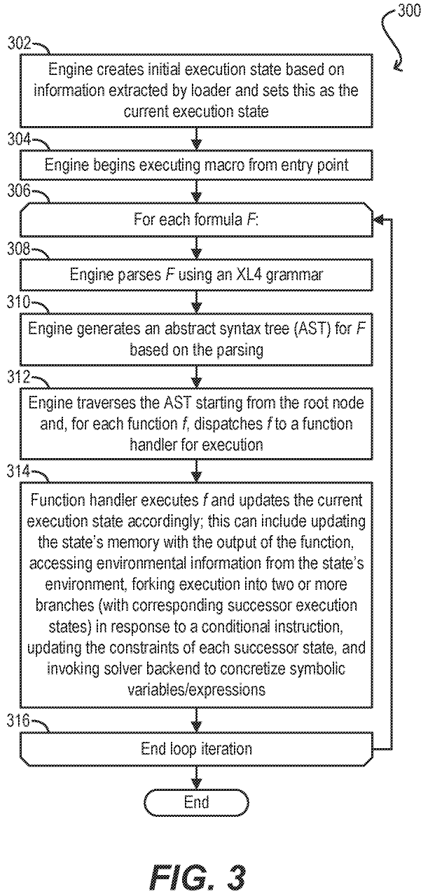

Once loader 202 has extracted the relevant information for macro 210 from file 208, engine 204 orchestrates symbolic exploration of the macro, which can include parsing the macro's formulas, dispatching each function in the formulas to appropriate function handlers, forking execution when a conditional instruction is reached, and calling solver backend 206 to concretize symbolic variables/expressions. FIG. 3 is a workflow 300 that illustrates this processing according to certain embodiments.

Starting with step 302, engine 204 can create an initial execution state using the information extracted by loader 202 and set this initial execution state as the current execution state for macro 210. In various embodiments, this execution state can include a memory component, an environment component, and a constraints component. The memory component holds the values and formulas contained in the cells of the macro sheet, information regarding those cells' properties (e.g., font information), and any defined names. The environment component holds information pertaining to the execution environment in which the macro is run (e.g., the height of the Excel window, the current operating system name and version, etc.) and in particular maintains a symbolic variable for each such piece of environmental information. And the constraints component holds symbolic variable constraints that are applicable to the current execution state based on prior forking events. Because the initial execution state is created before any forking events occur, its constraints component will initially be empty.

At steps 304 and 306, engine 204 can begin executing macro 210 from the macro's entry point and enter a loop for each encountered formula F. Within the loop, engine 204 can parse formula F using a set of extended Backus-Naur form (EBNF) rules that describe the syntactic structure of XL4 macro formulas (i.e., an XL4 grammar) (step 308). As a result of this parsing, engine 204 can generate an abstract syntax tree (AST) for formula F, where each node of the AST corresponds to a syntactic construct appearing in F (step 310). For example, in the case of formula =EXEC (“calc.exe”), the root node of its AST will correspond to the entire formula expression, a first child node of the root node will correspond to the EXEC function, and a second child node of the first child node will correspond to the input parameter “calc. exe.”

At step 312, engine 204 can traverse the generated AST starting from its root node and, for each node that corresponds to a function f, can dispatch f (with its input parameters) to an appropriate function handler. It is assumed that SYMBEXEL implements such function handlers for all non-terminal symbols (i.e., functions) of the XL4 grammar. In response, the function handler can execute function f and update the current execution state for macro 210 accordingly (step 314).

The specific scope of the state update operations performed at step 314 will vary depending on the nature of function f and its input parameters. At a minimum, the function handler will update the memory component of the current execution state to store f's output. For example, with respect to the formula in cell A1 of macro 100 of FIG. 1, the function handler for SET. VALUE will update the value in cell K1 with K1+1.

In cases where the output of function f is dependent on environmental information, the function handler can retrieve, from the environment component of the current execution state, the symbolic variable mapped to that environmental information. The function handler can then incorporate the symbolic variable into its output (as, e.g., a symbolic expression), thereby propagating it from the environment component to the memory component. For example, with respect to the formula in cell A4 of macro 100, the function handler for NOW can retrieve the symbolic variable associated with the current time and the function handler for FORMULA can incorporate that symbolic variable into its output that is written to cell K2. As a result of these operations, the symbolic variable will be carried forward and used in downstream computations for macro 100.

And in cases where function f is a conditional instruction (e.g., IF function) that is dependent upon at least one symbolic variable or expression, the function handler can (1) duplicate the current execution state into two or more successor execution states, each corresponding to a possible branch arising from the conditional instruction, and (2) update the constraints component of each successor state with one or more new constraints on the symbolic variable/expression that are relevant for that state's branch. SYMBEXCEL can then fork execution to follow those branches using their respective execution states, thereby allowing for a full exploration of all possible branches of macro 210. In one set of embodiments, SYMBEXCEL can implement this forking by recursively initiating a new instance of engine 204 for each branch and having the new instance start its symbolic exploration from the next formula after F in that branch.

For example, with respect to the formula in cell A3 of macro 100, the function handler for the IF function will create two successor execution states—a first state corresponding to the branch where K1 is less than 2 and a second state corresponding to the branch where K1 is greater than 2—and update the first and second successor states with the constraints K1<2 and K1>=2 respectively. SYMBEXCEL will then create two new instances of engine 204 that will follow these branches with their corresponding execution states, such that the first instance will proceed with parsing and executing CLOSE (TRUE) and the second instance will proceed with parsing and executing the formula in cell A4.

Notably, if any of the processing performed by the function handler at step 314 requires concretization of a symbolic variable or expression, the function handler can pass that symbolic variable/expression and the current execution state to solver backend 206. In response, solver backend 206 can return a concrete value for the symbolic variable/expression that is consistent with the constraints in the current execution state, thereby allowing the function handler to complete its processing. This will typically be needed for conditional instructions or other functions cannot be executed without concretization of its input parameters (e.g., EXEC, GOTO, etc.).

Finally, at step 316, engine 204 can reach the end of the current loop iteration and return to step 306 to process the next formula. Once all of the formulas in the macro have been processed, the workflow can end.

It should be appreciated that workflow 300 is illustrative and various modifications are possible. For example, although this workflow and the preceding description implies that engine 204 explores and executes all possible branches of macro 210, from a practical perspective this may not always be possible. For example, if macro 210 is particularly complex and a path explosion is encountered, it may not be computationally feasible for engine 204 to explore every branch. Accordingly, in this scenario engine 204 can intentionally cut short certain branches or choose not to explore some subset of branches.

Further, although workflow 300 assumes that SYMBEXCEL implements a function handler for every XL4 function, doing so necessarily requires the tool to reproduce the entire Excel formula engine. To mitigate this burden, in some embodiments engine 204 may offload (i.e., delegate) the execution of certain functions to a running instance of Excel via a COM interface, rather than using built-in function handlers. In particular, for each such function, engine 204 can provide its input parameters and the memory component of the current execution state to the Excel instance. The Excel instance can then execute the function in accordance with that current state and provide the result back to engine 204. This delegation mechanism advantageously reduces the implementation overhead for SYMBEXCEL when threat actors start using a newly introduced function.

### 2.3 Solver Backend

The last component of the SYMBEXCEL architecture is solver backend 206, which is invoked by engine 204 during its symbolic exploration to concretize symbolic variables/expressions. Solver backend 206 performs this task by checking the satisfiability of constraints accumulated in the current execution state and generating concrete values that are compatible with (i.e., satisfy) those constraints.

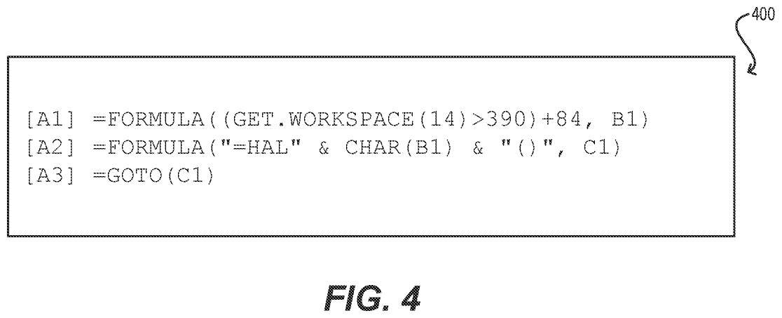

One challenge with integrating solver backend 206 with engine 204 in a performant way is that there will often be many possible concrete values for a given symbolic variable or expression. For example, consider the example macro 400 depicted in FIG. 4 and in particular the formula in cell A1 of this macro. Using symbolic execution, the result of this formula (written to cell B1) is a symbolic expression that includes a symbolic variable associated with the environmental information returned by GET. WORKSPACE (14). However, this symbolic variable is an integer variable with 2³² possible concrete values. Therefore, after executing cell A3 and transferring execution to the symbolic expression stored in cell C1, a naïve concretization strategy will cause engine 204 to fork 2³² execution states, thereby overloading it.

To address the foregoing and other related issues, the following sub-sections describe two optimizations—observers and smart concretization—that may be implemented by engine 204/solver backend 206 to make SYMBEXCEL's concretization strategy more efficient.

### 2.3.1 Observers

This optimization relies on the introduction of additional symbolic variables, referred to as observer variables, during the symbolic exploration process to make constraint solving more practical. In particular, when engine 204 executes a symbolic comparison operation, a symbolic Boolean operation, or an IS_NUMBER function on a symbolic string index (e.g., IS_NUMBER (SEARCH ( . . . )), engine 204 can represent the resulting Boolean expression using a new symbolic (observer) variable. This can dramatically reduce the concretization space that needs to be considered when concretizing a symbolic expression that includes that Boolean expression.

For example, assume solver backend 206 needs to concretize the symbolic expression (GET.WORKSPACE (14)>390)+84) shown in cell A1 of macro 400. Without the observers optimization, solver backend 206 will recognize that this expression includes a symbolic integer variable corresponding to the output of GET. WORKSPACE (14). Accordingly, solver backend 206 will generate 2³² possible values for the expression.

On the other hand, by introducing a symbolic Boolean variable OBSERVER_1 to represent the Boolean expression GET. WORKSPACE (14)>390, the overall symbolic expression becomes OBSERVER_1+84. Accordingly, this expression has only two possible concrete values, 84 and 85, which allows solver backend 206 to concretize it with minimal overhead.

### 2.3.2 Smart Concretization

Even after introducing one or more observer variables, it is possible to have too many concrete values associated with a symbolic variable/expression. To further limit these values, solver backend 206 can implement smart concretization, which involves using the XL4 grammar to determine whether a concrete string is a valid formula or not. In other words, after determining every concrete value for a symbolic variable/expression, solver backend 206 can use the XL4 grammar to filter out any invalid formulas.

For example, returning to macro 400 of FIG. 4, there are two possible concretizations of the string stored in cell C1: =HALT ( ) and =HALU ( ). While the first concretization represents a valid formula, the second one is invalid and thus can be discarded by solver backend 206. This smart concretization strategy is without loss of generality because Excel also aborts execution when it encounters an invalid formula. In other words, malware authors cannot deceive SYMBEXCEL into discarding an otherwise legitimate payload by intentionally using an invalid formula.

Certain embodiments described herein can employ various computer-implemented operations involving data stored in computer systems. For example, these operations can require physical manipulation of physical quantities-usually, though not necessarily, these quantities take the form of electrical or magnetic signals, where they (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a generic computer system comprising one or more general purpose processors (e.g., Intel or AMD x86 processors) selectively activated or configured by program code stored in the computer system. In particular, various generic computer systems may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any storage device, based on any existing or subsequently developed technology, that can store data and/or computer programs in a non-transitory state for access by a computer system. Examples of non-transitory computer readable media include a hard drive, network attached storage (NAS), read-only memory, random-access memory, flash-based nonvolatile memory (e.g., a flash memory card or a solid state disk), persistent memory, NVMe device, a CD (Compact Disc) (e.g., CD-ROM, CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. These examples and embodiments should not be deemed to be the only embodiments and are presented to illustrate the flexibility and advantages of particular embodiments as defined by the following claims. Other arrangements, embodiments, implementations, and equivalents can be employed without departing from the scope hereof as defined by the claims.

What is claimed is:

1. A method comprising:
receiving, by a computer system, an Excel file including an Excel 4.0 (XL4) macro; and
executing, by the computer system, the XL4 macro via symbolic execution, the executing comprising:
using a plurality of symbolic variables to model environmental information employed by the XL4 macro to obfuscate one or more malicious actions; and
upon reaching a conditional instruction that depends on a first symbolic variable in the plurality of symbolic variables, forking execution of the macro into two or more branches and tracking constraints for the first symbolic variable that are introduced by the forking in an execution state for each branch; and
upon reaching a formula of the XL4 macro that requires concretization of a second symbolic variable in the plurality of symbolic variables, translating the second symbolic variable into a concrete value that satisfies the constraints.

2. The method of claim 1 further comprising:
generating a report of security-relevant formulas (SRFs) found in the XL4 macro during the executing.

3. The method of claim 1 further comprising:
extracting information from the Excel file that is relevant for the executing, the information including content of each spreadsheet in the Excel file and an entry point of the XL4 macro.

4. The method of claim 3 wherein the executing further comprises:
initiating the executing from the entry point; and
for each formula encountered during the executing:
parsing the formula using an XL4 grammar;
generating an abstract syntax tree (AST) for the formula based on the parsing;
traversing the AST; and
for one or more functions in the AST, dispatching the function to a corresponding function handler for execution.

5. The method of claim 4 wherein at least one function in the AST is dispatched to a running instance of Excel for execution.

6. The method of claim 1 wherein the executing further comprises:
upon executing a comparison or Boolean operation that involves a symbolic variable and results in a Boolean expression, representing the Boolean expression using a new symbolic variable.

7. The method of claim 1 wherein the translating comprises:
determining all possible concrete values for the second symbolic variable that satisfies the constraints; and
filtering, from said all possible concrete values, any concrete values that correspond to invalid formulas according to an XL4 grammar.

8. A non-transitory computer readable storage medium having stored thereon program code executable by a computer system, the program code embodying a method comprising:
receiving an Excel file including an Excel 4.0 (XL4) macro; and
executing the XL4 macro via symbolic execution, the executing comprising:
using a plurality of symbolic variables to model environmental information employed by the XL4 macro to obfuscate one or more malicious actions; and
upon reaching a conditional instruction that depends on a first symbolic variable in the plurality of symbolic variables, forking execution of the macro into two or more branches and tracking constraints for the first symbolic variable that are introduced by the forking in an execution state for each branch; and
upon reaching a formula of the XL4 macro that requires concretization of a second symbolic variable in the plurality of symbolic variables, translating the second symbolic variable into a concrete value that satisfies the constraints.

9. The non-transitory computer readable storage medium of claim 8 wherein the method further comprises:
generating a report of security-relevant formulas (SRFs) found in the XL4 macro during the executing.

10. The non-transitory computer readable storage medium of claim 8 wherein the method further comprises:
extracting information from the Excel file that is relevant for the executing, the information including content of each spreadsheet in the Excel file and an entry point of the XL4 macro.

11. The non-transitory computer readable storage medium of claim 10 wherein the executing further comprises:
initiating the executing from the entry point; and
for each formula encountered during the executing:
parsing the formula using an XL4 grammar;
generating an abstract syntax tree (AST) for the formula based on the parsing;
traversing the AST; and
for one or more functions in the AST, dispatching the function to a corresponding function handler for execution.

12. The non-transitory computer readable storage medium of claim 11 wherein at least one function in the AST is dispatched to a running instance of Excel for execution.

13. The non-transitory computer readable storage medium of claim 8 wherein the executing further comprises:
upon executing a comparison or Boolean operation that involves a symbolic variable and results in a Boolean expression, representing the Boolean expression using a new symbolic variable.

14. The non-transitory computer readable storage medium of claim 8 wherein the translating comprises:
determining all possible concrete values for the second symbolic variable that satisfies the constraints; and
filtering, from said all possible concrete values, any concrete values that correspond to invalid formulas according to an XL4 grammar.

15. A computer system comprising:
a processor; and
a non-transitory computer readable medium having stored thereon program code that, when executed by the processor, causes the processor to:
receive an Excel file including an Excel 4.0 (XL4) macro; and
execute the XL4 macro via symbolic execution, the executing comprising:
using a plurality of symbolic variables to model environmental information employed by the XL4 macro to obfuscate one or more malicious actions; and
upon reaching a conditional instruction that depends on a first symbolic variable in the plurality of symbolic variables, forking execution of the macro into two or more branches and tracking constraints for the first symbolic variable that are introduced by the forking in an execution state for each branch; and
upon reaching a formula of the XL4 macro that requires concretization of a second symbolic variable in the plurality of symbolic variables, translating the second symbolic variable into a concrete value that satisfies the constraints.

16. The computer system of claim 15 wherein the program code further causes the processor to:
generate a report of security-relevant formulas (SRFs) found in the XL4 macro during the executing.

17. The computer system of claim 15 wherein the program code further causes the processor to:
extract information from the Excel file that is relevant for the executing, the information including content of each spreadsheet in the Excel file and an entry point of the XL4 macro.

18. The computer system of claim 17 wherein the executing further comprises:
initiating the executing from the entry point; and
for each formula encountered during the executing:
parsing the formula using an XL4 grammar;
generating an abstract syntax tree (AST) for the formula based on the parsing;
traversing the AST; and
for one or more functions in the AST, dispatching the function to a corresponding function handler for execution.

19. The computer system of claim 18 wherein at least one function in the AST is dispatched to a running instance of Excel for execution.

20. The computer system of claim 15 wherein the executing further comprises:
upon executing a comparison or Boolean operation that involves a symbolic variable and results in a Boolean expression, representing the Boolean expression using a new symbolic variable.

21. The computer system of claim 15 wherein the translating comprises:
determining all possible concrete values for the second symbolic variable that satisfies the constraints; and
filtering, from said all possible concrete values, any concrete values that correspond to invalid formulas according to an XL4 grammar.
